(19) United States
(12) Patent Application Publication
(10) Pub. No.: US 2026/0147960 A1
(43) Pub. Date: May 28, 2026

(54) THERMAL SIMULATION SYSTEM AND METHOD FOR SYSTEM-ON-CHIP

(71) Applicant: MEDIATEK INC., Hsinchu City (TW)

(72) Inventors: Yu-Sheng LIN, Hsinchu City (TW); Ya-Wen YU, Hsinchu City (TW); Shih-Hong PAN, Hsinchu City (TW); Kai-En YANG, Hsinchu City (TW); Wei-Cheng LEE, Hsinchu City (TW); Yi-Chen LIN, Hsinchu City (TW); Chia-Shun YEH, Hsinchu City (TW); Li-Song LIN, Hsinchu City (TW); Ting-Yu LIN, Hsinchu City (TW); Tai-Yu CHEN, Hsinchu City (TW); Chia-Yu TSAI, Hsinchu City (TW)

(21) Appl. No.: 18/960,072

(22) Filed: Nov. 26, 2024

(51) Int. Cl. G06F 30/27; G06F 115/02; G06F 119/08

(52) U.S. Cl. CPC G06F 30/27; G06F 2115/02; G06F 2119/08

(57) ABSTRACT

A machine-learning based, rapid, physics-aware thermal simulator, drawing inspiration from the Fourier's law and the Fourier-Biot equation, the first and second derivatives of the temperature map, is provided. The learning objective evolves from merely translating images to approximating natural phenomena such as the thermal gradient and thermal Laplacian. By adding an additional encoder during training and substituting the image-based loss with the thermal-aware loss, the proposed model achieves lower prediction error, higher data efficiency, and more physically accurate behavior.

### BACKGROUND OF THE INVENTION

### Field of the Invention

The present invention relates to machine learning and thermal simulation, and, in particular, to a thermal simulation system and method for a system-on-chip (SoC).

### Description of the Related Art

The growing demand for high performance in mobile, 5G and AI computing applications is increasing the criticality and challenge of thermal management design. Fast SoC thermal simulation plays a crucial role in integrated circuit (IC) design, particularly as power density escalates with increasing demand for computational capabilities. High temperatures can lead to CPU overheating or thermal throttling, resulting in decreased device performance and poor user experiences. This issue is further exacerbated by the advent and development of 3D-stacked chiplets. Moreover, complexities of SoC Interlecture Property (IP) placement design, involving various target IPs and multiple physical constraints such as thermal, IR drop, and timing, lead to an extensive design of experiments (DOE).

Additionally, the integrated circuit (IC) industry faces significant time constraints, while conventional thermal simulation methods using Computational Fluid Dynamics (CFD) tools are highly time-consuming. Typically, it takes dozens of minutes to several hours to perform a steady-state thermal simulation with CFD tools. This prolonged simulation time poses a bottleneck for iterative design processes, where rapid feedback is essential to optimize thermal performance across multiple design iterations.

In view of these challenges, there is an urgent need for a thermal simulation system and method capable of delivering rapid feedback from power input to temperature output.

### BRIEF SUMMARY OF THE INVENTION

An embodiment of the present invention provides a thermal simulation system for a System-on-Chip (SoC). The thermal simulation system includes a storage unit and a processing unit. The storage unit is configured to store a temperature prediction model. The processing unit is configured to load the temperature prediction model from the storage unit, and use the temperature prediction model to translate a power map of a floorplan of the SoC into a temperature map. The processing unit is further configured to train the temperature prediction model by executing operations including using a power encoder and a temperature decoder to generate a predicted temperature map from a training power map, using the power encoder and a thermal gradient decoder to generate a predicted thermal gradient map from the training power map, applying the Sobel operator on the predicted temperature map to obtain a computed thermal gradient map, applying the Sobel operator on a ground-truth temperature map to obtain a ground-truth thermal gradient map, calculating an image-based loss based on the predicted temperature map and the ground-truth temperature map, calculating a physics-aware loss based on the computed thermal gradient map, the predicted thermal gradient map, and the ground-truth thermal gradient map, and optimizing the power encoder, the temperature decoder, and the thermal gradient decoder based on the image-based loss and the physics-aware loss. The trained power encoder and temperature decoder are deployed as the temperature prediction model.

In an embodiment, the processing unit is further configured to use the power encoder and the thermal gradient decoder to generate a predicted thermal Laplacian map from the training power map. The processing unit is further configured to apply the Laplacian operator on the predicted temperature map to obtain a computed thermal Laplacian map. The processing unit is further configured to calculate a thermal gradient loss based on the computed thermal gradient map, the predicted thermal gradient map, and the ground-truth thermal gradient map. The processing unit is further configured to calculate a thermal Laplacian loss based on the computed thermal Laplacian map, the predicted thermal Laplacian map, and the ground-truth thermal Laplacian map. The processing unit is further configured to calculate the physics-aware loss based on the thermal gradient loss and the thermal Laplacian loss.

In an embodiment, he processing unit is further configured to calculate the physics-aware loss as a weighted sum of the thermal gradient loss and the thermal Laplacian loss.

In an embodiment, the image-based loss, the thermal gradient loss, and the thermal Laplacian loss are calculated using mean-square error (MSE).

In an embodiment, the processing unit is further configured to identify thermal hotspots in temperature map and adjust placement of components in the floorplan based on the identified thermal hotspots to reduce thermal concentration. The SoC, after being optimized for thermal performance through the adjusted floorplan, is provided for manufacturing.

An embodiment of the present invention provides a thermal simulation method for a System-on-Chip (SoC). The thermal simulation method is carried out by a computer system. The thermal simulation method includes using a power encoder and a temperature decoder to generate a predicted temperature map from a training power map, using the power encoder and a thermal gradient decoder to generate a predicted thermal gradient map from the training power map, applying the Sobel operator on the predicted temperature map to obtain a computed thermal gradient map, applying the Sobel operator on a ground-truth temperature map to obtain a ground-truth thermal gradient map, calculating an image-based loss based on the predicted temperature map and the ground-truth temperature map, calculating a physics-aware loss based on the computed thermal gradient map, the predicted thermal gradient map, and the ground-truth thermal gradient map, and optimizing the power encoder, the temperature decoder, and the thermal gradient decoder based on the image-based loss and the physics-aware loss. The trained power encoder and temperature decoder are deployed as the temperature prediction model.

In an embodiment, the thermal simulation method further includes using the power encoder and the thermal gradient decoder to generate a predicted thermal Laplacian map from the training power map, applying the Laplacian operator on the predicted temperature map to obtain a computed thermal Laplacian map, applying the Laplacian operator on the ground-truth temperature map to obtain a ground-truth thermal Laplacian map, calculating a thermal gradient loss based on the computed thermal gradient map, the predicted thermal gradient map, and the ground-truth thermal gradient map, calculating a thermal Laplacian loss based on the computed thermal Laplacian map, the predicted thermal Laplacian map, and the ground-truth thermal Laplacian map, and calculating the physics-aware loss based on the thermal gradient loss and the thermal Laplacian loss.

In an embodiment, the thermal simulation method further includes identifying thermal hotspots in the temperature map, and adjusting placement of components in the floorplan based on the identified thermal hotspots to reduce thermal concentration. The SoC, after being optimized for thermal performance through the adjusted floorplan, is provided for manufacturing.

### BRIEF DESCRIPTION OF THE DRAWINGS

The present invention can be more fully understood by reading the subsequent detailed description and examples with references made to the accompanying drawings, wherein:

FIG. 1 is the system block diagram of a thermal simulation system, according to an embodiment of the present disclosure;

FIG. 2 shows an example of power map and the corresponding temperature map thereof, according to an embodiment of the present disclosure;

FIG. 3 shows a ground-truth map and examples of two corresponding predicted temperature maps;

FIG. 4 illustrates the data flow of the training phase of the temperature prediction model in a thermal simulation method, according to an embodiment of the present disclosure;

FIG. 5A and FIG. 5B illustrate the data flow of the training phase of the temperature prediction model in a thermal simulation method, according to a further embodiment of the present disclosure; and

FIG. 6A and FIG. 6B illustrate the performance of the physics-aware model and the purely image-based model in terms of MSE and MTE, respectively, according to an embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The descriptions hereinafter for embodiments of devices or systems are also applicable to embodiments of methods, and vice versa.

Thermal analysis, in general, can be executed either through empirical experimentation or computational simulations. Within the field of mobile SoC design, simulations are predominantly used to achieve optimized thermal designs. However, exploring thermally critical floorplan placement scenarios and evaluating their associated power settings often requires considerable computational time, particularly when using conventional methods like Computational Fluid Dynamics (CFD) tools.

Emerging approaches leverage Deep Neural Networks (DNNs) to accelerate the thermal simulation process. These approaches can be broadly categorized into two types: generalized models and application-specific models. Generalized models use neural networks to solve differential equations through universal frameworks, often requiring the specification of domain-specific parameters such as boundary conditions and governing equations. While this approach provides flexibility, it may demand substantial domain knowledge and configuration effort.

In contrast, application-specific models focus on directly mapping input data, such as power maps, to output data, such as temperature maps, for specific scenarios. These models can be trained with paired input-output datasets, utilizing a convolutional encoder-decoder networks architecture such as U-net. While this approach simplifies the training process and enables faster results, it may risk overlooking the underlying physical natures governing thermal behaviors, such as spatial continuity and physical consistency. As a result, the effectiveness of these models often relies heavily on the availability of comprehensive and high-quality training datasets.

In summary, generic-physics models rely on extensive expertise to incorporate domain-specific knowledge, while task-specific models typically require less domain knowledge but depend heavily on large amounts of training data. The present disclosure presents a promising approach, which involves integrating physical constraints into task-specific models to enhance their accuracy and reduce data requirements, and rendering a steady-state thermal simulator capable of rapid power-to-temperature mapping.

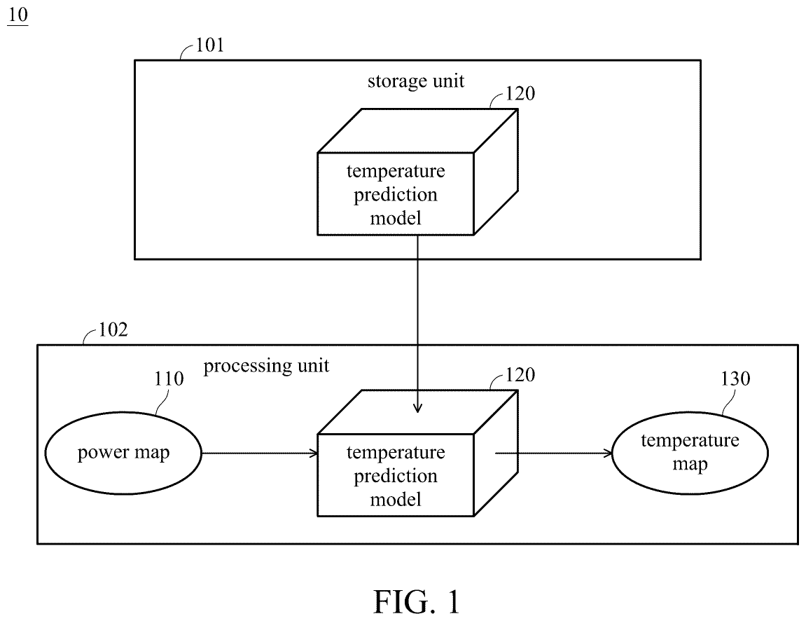

FIG. 1 is the system block diagram of a thermal simulation system 10, according to an embodiment of the present disclosure. As shown in FIG. 1, the thermal simulation system 10 includes a storage unit 101 and a processing unit 102, each of which will be introduced below.

The thermal simulation system 10 can be any computer system with computing capabilities, such as a personal computer (e.g., a desktop or laptop computer) or a server computer running an operating system (e.g., Windows, Mac OS, Linux, or UNIX). Alternatively, the thermal simulation system 10 can also be a mobile device such as a tablet or smartphone, but the present disclosure is not limited thereto.

The storage unit 101 may include one or more non-transitory computer-readable storage media that contain non-volatile memory, such as read-only memory (ROM), electrically-erasable programmable read-only memory (EEPROM), flash memory, or non-volatile random access memory (NVRAM). These storage media may include, but are not limited to, hard disk drives (HDD), solid-state drives (SSD), optical disks, or any combination thereof.

The processing unit 102 may include one or more general-purpose or specialized processors, or a combination thereof, capable of executing instructions. The processing unit 102 may further include volatile memory such as Random Access Memory (RAM), Dynamic Random Access Memory (DRAM), and/or other types of high-speed memory, which work in conjunction with the processors to store and quickly access data and instructions during execution.

In an embodiment, the processing unit 102 includes a Central Processing Unit (CPU) and a Graphics Processing Unit (GPU). A GPU is specifically designed to perform computer graphics calculations and image analysis, making it more efficient for these tasks compared to a general-purpose CPU. Therefore, tasks may be assigned based on the characteristics of the CPU and GPU, such as assigning tasks related to data acquisition or communication with other devices to the CPU and tasks related to computer graphics calculations and image analysis to the GPU. In further embodiments, the processing unit 102 may further include a Neural Processing Unit (NPU), which is optimized for deep learning. Compared to a GPU, an NPU may offer superior computational performance for tasks related to the training and inference of a deep learning model. Therefore, in these embodiments, operations involving model training and inference can be assigned to the NPU to achieve improved efficiency and performance.

In an embodiment, the storage unit 101 stores a computer-executable program (though not shown in FIG. 1), which can be written in any known programming language, such as Python, C++, or Java. This program contains instructions that, when executed by the processing unit 102, cause the thermal simulation system 10 to perform steps or operations of the thermal simulation method disclosed herein.

As shown in FIG. 1, the storage unit 101 is configured to store a temperature prediction model 120. The processing unit 102 is configured to execute a thermal simulation method, which involves loading the temperature prediction model 120 from the storage unit 101 and using the temperature prediction model 120 to translate a power map 110 of an SoC floorplan into a temperature map 130 during the inference phase of the temperature prediction model 120.

The temperature prediction model 120 is designed to perform image-to-image translation between two domains, specifically translating power maps to temperature maps. The model features an architecture comprising an encoder, a decoder, and skip connections. The encoder is responsible for extracting hierarchical feature representations from the input power map, progressively reducing its spatial dimensions while capturing latent semantic features. The decoder reconstructs the output temperature map by upsampling these features to their original spatial dimensions, transforming the encoded features into the desired output domain. Skip connections bridge corresponding layers between the encoder and decoder, allowing the direct transfer of spatial information that might otherwise be lost during the encoding process. This architecture can be implemented using convolutional encoder-decoder networks, such as a U-Net, DeepLabV3+, Pix2Pix, and V-net, but the present disclosure is not limited thereto. The temperature prediction model 120 is trained using paired power maps and temperature maps, which serve as the training dataset. These training pairs can be collected through conventional approaches, such as the aforementioned CFD tools, but the present disclosure is not limited thereto. Further details regarding the training of the temperature prediction model 120 will be elaborated hereinafter.

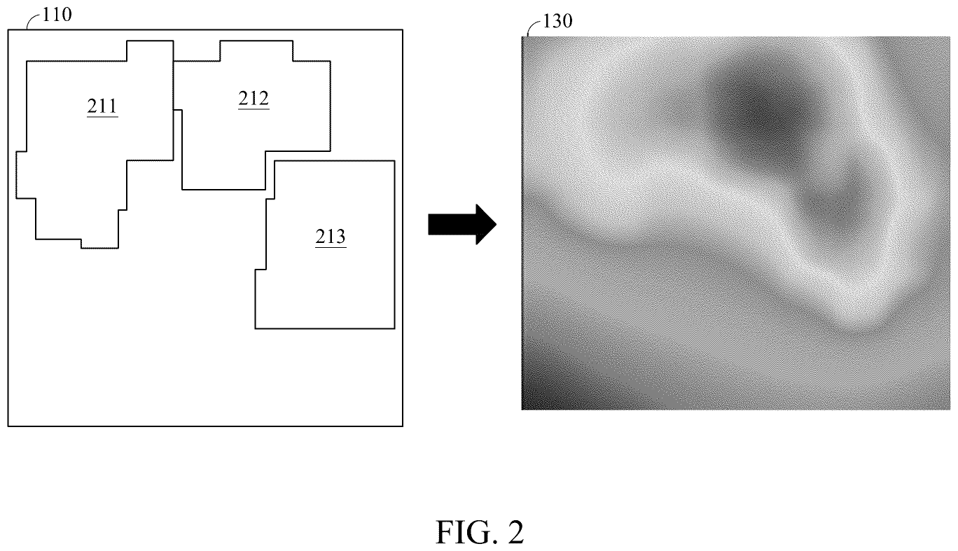

FIG. 2 shows an example of power map 110 and the corresponding temperature map 130 thereof, according to an embodiment of the present disclosure. As illustrated in FIG. 2, the power map 110 is an image representing the energy generation rate per unit area within an SoC floorplan. It may be noted that, in some embodiments, the power map may be an image representing the energy generation rate per unit volume. In the example as shown in FIG. 2, the power map 110 is a rectilinear representation that highlights regions of power dissipation. For example, areas 211, 212, and 213 in the power map correspond to power dissipation rates of 1 W, 3 W, and 1.5 W, respectively. These power values indicate localized energy generation in different functional blocks of the SoC.

The temperature map 130, on the other hand, represents the temperature distribution corresponding to the power map 110. In the example as shown in FIG. 2, the temperature map 130 uses a color gradient to visualize the thermal profile, where warmer colors (e.g., red) represent higher temperatures, and cooler colors (e.g., blue) represent lower temperatures. This temperature distribution reflects the thermal response of the SoC based on the power dissipation rates and other thermal properties.

It should be noted that FIG. 2 merely shows an example and does not limit the specific visual representations of the power map 110 and the temperature map 130. In various embodiments of the present disclosure, the power map 110 and temperature map 130 can be presented in other forms, such as grayscale intensity images, contour plots, or 3D surface visualizations, depending on the application requirements.

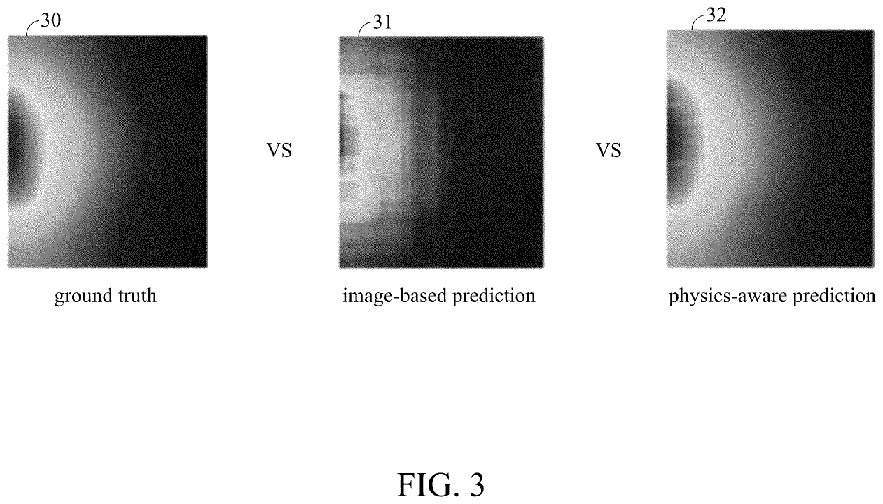

FIG. 3 shows a ground-truth temperature map 30 and examples of two corresponding predicted temperature maps 31 and 32. The predicted temperature map 31 is an image-based prediction output by a temperature prediction model that considers only image analysis aspects. In contrast, the predicted temperature map 32 is a physics-aware prediction output by a temperature prediction model that incorporates thermal physics.

As shown in FIG. 3, the predicted temperature map 32 output by a physics-aware model more closely resembles the ground-truth temperature map 30 compared to the predicted temperature map 31 output by an image-based model. Specifically, the predicted temperature map 32 exhibits smoother gradients and a more accurate representation of the temperature distribution, particularly in regions near the peak temperature. Additionally, the predicted temperature map 32 better captures the spatial continuity of the temperature field, ensuring a consistent transition between high-temperature and low-temperature regions. In contrast, the predicted temperature map 31 shows noticeable artifacts, such as abrupt changes in temperature values and inaccuracies in the thermal peak location. These differences highlight the advantages of integrating thermal physics into the prediction model, enabling the physics-aware model to produce results that align more closely with the ground-truth temperature distribution.

In physics, the temperature relationship between adjacent grids can be described by Fourier's law, as expressed in <F1>:

$${q}_{v} = - k ∇ T \qquad < F 1 >$$

where qᵥ represents the energy generation rate per unit volume, k represents the thermal conductivity of the material, and ∇T represents the temperature gradient. Fourier's law states that the rate of heat transfer is proportional to the negative temperature gradient.

In three dimensions, this relationship extends to the Fourier-Biot equation, as expressed in <F2>.

$$\frac{\partial }{\partial x} ( k \frac{\partial T}{\partial x} ) + \frac{\partial }{\partial y} ( k \frac{\partial T}{\partial y} ) + \frac{\partial }{\partial z} ( k \frac{\partial T}{\partial z} ) + q = ρ c \frac{\partial T}{\partial t} \qquad < F 2 >$$

where ρ and c represent the density and specific heat of the material, respectively, while q represents the power source. This equation governs the distribution and temporal evolution of temperature in three-dimensional space, accounting for material properties, heat sources, and thermal conductivity.

The Fourier-Biot equation is a general heat conduction equation that describes the energy conservation property in rectangular coordinates. Under steady-state conditions, where

$$\frac{\partial T}{\partial t}$$

is zero, it simplifies to describe the equilibrium state of heat conduction. This principle inspires a physics-aware network architecture that emulates the properties of the heat conduction equation. On the other hand, during the training phase of the temperature prediction model 120, the loss function plays a crucial role as it evaluates the model's performance and serves as the basis for optimizing the model parameters. The design of the loss function must effectively reflect the underlying physical properties of heat conduction, in order to guide the model optimization toward more accurate and physically consistent predictions. Therefore, a novel physics-aware network architecture and a specially designed loss function for training the temperature prediction model 120 are proposed in the present disclosure, and will be elaborated hereinafter.

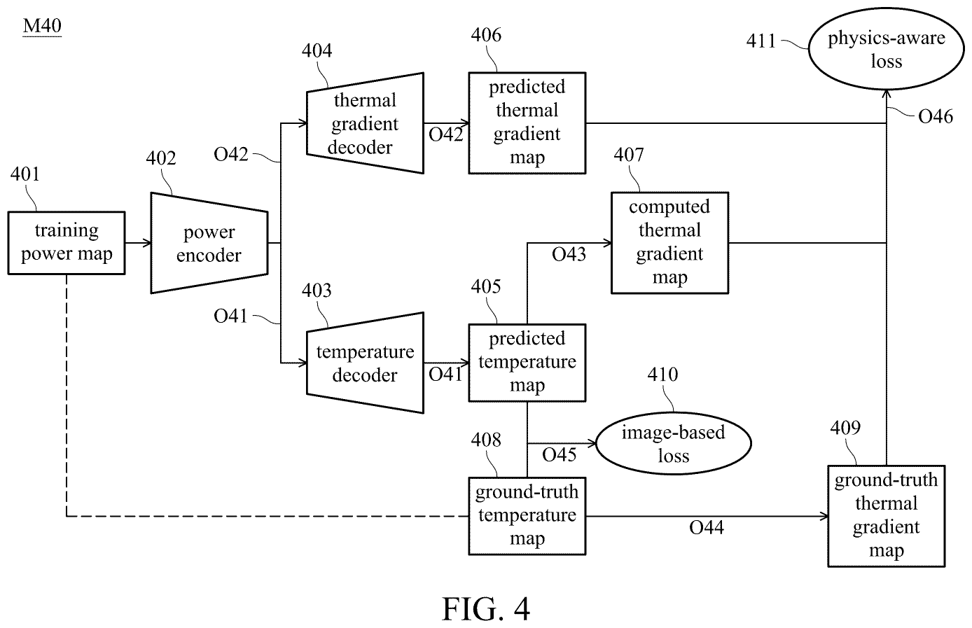

As previously described, the thermal simulation method carried out by the thermal simulation system 10 involves using the temperature prediction model 120 to translate a power map 110 into a temperature map 130 during the inference phase of the temperature prediction model 120. Further details regarding the training phase of the temperature prediction model 120 will be elaborated below with reference to FIG. 4. To distinguish the power map used as training data during the training phase from the power map 110 involved in the inference phase, the power map used during the training phase will be referred to as the “training power map.”

FIG. 4 illustrates the data flow of the training phase of the temperature prediction model in a thermal simulation method M40, according to an embodiment of the present disclosure. As shown in FIG. 4, the training phase of the temperature prediction model may involve operations O41-O46, among others. Each of these operations will be elaborated below.

The operation O41 involves using the power encoder 402 and the temperature decoder 403 to generate the predicted temperature map 405 from the training power map 401. Specifically, the power encoder 402 extracts hierarchical feature representations from the training power map 401, capturing both spatial and semantic information related to power distribution of an SoC floorplan. The temperature decoder 403 reconstructs the predicted temperature map 405 by transforming the encoded features into a spatial representation that aligns with the temperature distribution, effectively retaining both low-level spatial details and high-level thermal patterns. As a result, the predicted temperature map 405 can provide image-based insights into the thermal distribution characteristics of the SoC floorplan during the model-training phase.

The operation O42 involves using the power encoder 402 and the thermal gradient decoder 404 to generate the predicted thermal gradient map 406 from the training power map 401. Specifically, the power encoder 402 extracts hierarchical feature representations from the training power map 401, capturing both spatial and semantic information related to power distribution of an SoC floorplan. The thermal gradient decoder 404 reconstructs the predicted thermal gradient map 406 by focusing on the spatial temperature gradients that characterize thermal physics. Unlike a conventional U-net architecture, which comprises a single decoder, the additional thermal gradient decoder 404 is specifically designed to emulate the intricate relationships between adjacent temperature values, enabling the generation of gradient information that reflects the underlying thermal physics. As a result, the predicted thermal gradient map 406 can provide a physics-aware representation of heat flow patterns within the SoC floorplan during the model-training phase.

The operation O43 involves applying the Sobel operator on the predicted temperature map 405 to obtain the computed thermal gradient map 407. Specifically, the Sobel operator uses two 3×3 kernels to convolve with the predicted temperature map 405 to calculate approximations of horizontal and vertical derivatives. As a result, the computed thermal gradient map 407 can provide an approximation of the spatial temperature gradients present in the predicted temperature map 405.

However, it should be noted that the computed thermal gradient map 407 differs from the predicted thermal gradient map 406. While the computed thermal gradient map 407 is derived directly from the predicted temperature map 405 using the Sobel operator, the predicted thermal gradient map 406 is generated by the thermal gradient decoder 404 during the training phase and aims to reflect the spatial temperature gradients as part of the network's learning process. Consequently, the computed thermal gradient map 407 reflects the gradient information obtained through numerical approximation, whereas the predicted thermal gradient map 406 encapsulates the decoder's understanding of thermal physics based on learned features.

The operation O44 involves applying the Sobel operator on the ground-truth temperature map 408 to obtain the ground-truth thermal gradient map 409. The ground-truth temperature map 408 corresponds to the training power map 401, and the paired ground-truth temperature map 408 and training power map 401 collectively forms a training data instance. The ground-truth temperature map 408 and the ground-truth thermal gradient map 409 serve as benchmarks for evaluating the outputs of the temperature decoder 403 and the thermal gradient decoder 404, respectively. In other words, the ground-truth temperature map 408 and the ground-truth thermal gradient map 409 provide references to assess how accurately the predicted temperature map 405 and the predicted thermal gradient map 406 align with the actual thermal characteristics represented in the training data.

The operation O45 involves calculating the image-based loss 410 based on the predicted temperature map 405 and the ground-truth temperature map 408. The image-based loss 410 represents the discrepancy between the predicted temperature map 405 and the ground-truth temperature map 408 from an image analysis perspective. It quantifies differences in pixel-wise temperature values, focusing on visual and numerical aspects without considering underlying thermal physics. This loss provides a measure of how well the predicted temperature map 405 aligns with the spatial temperature distribution reflected in the ground-truth temperature map 408.

The operation O46 involves calculating the physics-aware loss 411 based on the predicted thermal gradient map 406, the computed thermal gradient map 407, and the ground-truth thermal gradient map 409. Specifically, the ground-truth thermal gradient map 409 is compared with the predicted thermal gradient map 406 and the computed thermal gradient map 407, respectively, to evaluate the discrepancy between ground truths and predictions. The physics-aware loss 411 aggregates the discrepancy between the predicted thermal gradient map 406 and the ground-truth thermal gradient map 409, as well as the discrepancy between the computed thermal gradient map 407 and the ground-truth thermal gradient map 409. Unlike the image-based loss 410, which evaluates the pixel-wise temperature accuracy from an image analysis perspective, the physics-aware loss 411 is designed to reflect the alignment with thermal physics by capturing the accuracy of the spatial temperature gradients. As a result, the physics-aware loss 411 can guide the model toward producing outputs with both higher visual accuracy and greater physics fidelity.

Though not illustrated in FIG. 4, the training phase of the temperature prediction model in the thermal simulation method M40 may further involve optimizing the power encoder 402, the temperature decoder 403, and the thermal gradient decoder 404 based on the image-based loss 410 and the physics-aware loss 411. Specifically, the image-based loss 410 and the physics-aware loss 411 are aggregated into a total loss, reflecting a balanced consideration of visual accuracy and physical fidelity during training. The total loss is backpropagated through the network to compute gradients with respect to the parameters of the power encoder 402, the temperature decoder 403, and the thermal gradient decoder 404. These gradients are then used to iteratively update the model parameters through an optimization algorithm, such as gradient descent or its variants, to minimize the total loss. Once the training phase is complete, the trained power encoder 402 and temperature decoder 403 are deployed as the temperature prediction model during the inference phase.

Although FIG. 4 illustrates a single training power map as an example for simplicity, it should be appreciated by persons skilled in the art that the training phase can involve multiple training power maps and their corresponding ground-truth temperature maps, which collectively form the training dataset used to optimize the temperature prediction model.

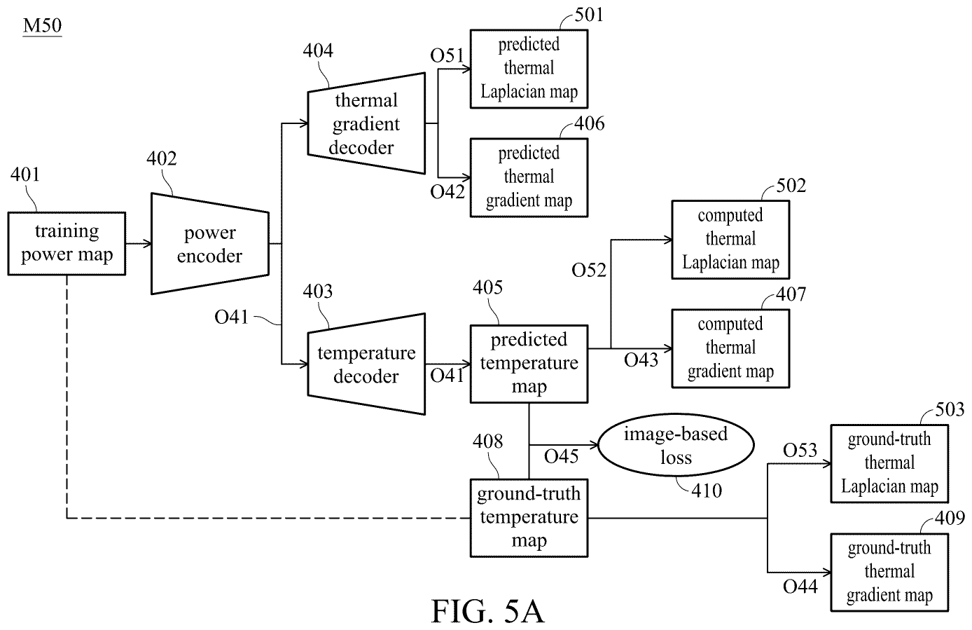

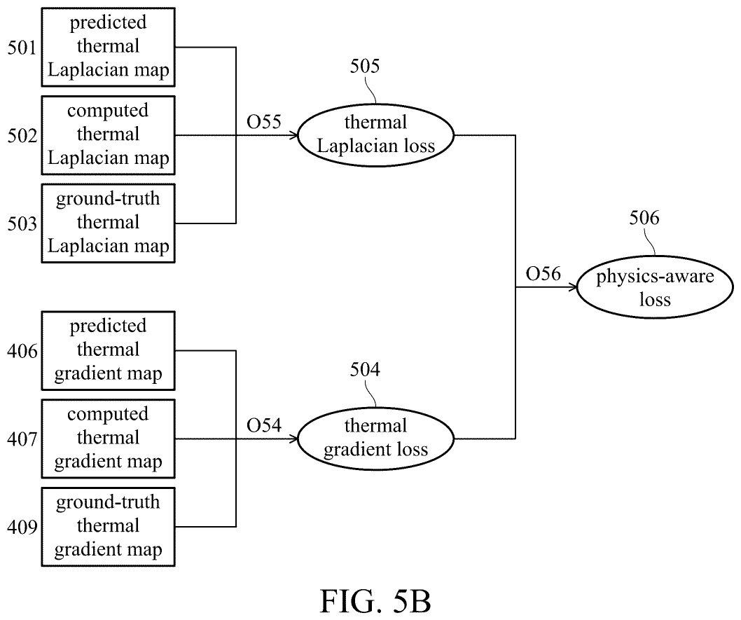

FIG. 5A and FIG. 5B illustrate the data flow of the training phase of the temperature prediction model in a thermal simulation method M50, according to a further embodiment of the present disclosure. As shown in FIG. 5A and FIG. 5B, the training phase of the temperature prediction model may further involve operations O51-O56, in addition to operations O41-O44 described previously. Each of these additional operations will be elaborated below.

Refer to FIG. 5A. The operation O51 involves using the power encoder 402 and the thermal gradient decoder 404 to generate the predicted thermal Laplacian map 501 from the training power map 401. Specifically, the power encoder 402 extracts hierarchical feature representations from the training power map 401, capturing both spatial and semantic information related to power distribution of an SoC floorplan. In addition to reconstructing the predicted thermal gradient map 406 based on the extracted features, the thermal gradient decoder 404 further reconstruct the predicted thermal Laplacian map 501 that reflects second-order spatial relationships by learning the Laplacian of the temperature distribution, which represents the rate of change of the thermal gradient. This process enables the thermal gradient decoder 404 to capture more profound thermal physics information, extending beyond first-order gradient approximations. As a result, the predicted thermal Laplacian map 501 can provide a physics-aware representation of thermal behavior within the SoC floorplan.

The operation O52 involves applying the Laplacian operator on the predicted temperature map 405 to obtain the computed thermal Laplacian map 502. Specifically, the Laplacian operator calculates the second-order spatial derivatives of the predicted temperature map 405 by combining the second partial derivatives in both horizontal and vertical directions. As a result, the computed thermal Laplacian map 502 provides a numerical approximation of the thermal curvature present in the predicted temperature map 405.

The operation O53 involves applying the Laplacian operator on the ground-truth temperature map 408 to obtain the ground-truth thermal Laplacian map 503. Thus, the ground-truth temperature map 408, the ground-truth gradient map 409, and the ground-truth thermal Laplacian map 503, representing the actual spatial temperature distribution, the first-order spatial temperature gradients, and the second-order spatial temperature derivatives, respectively, serve as benchmarks for evaluating the predicted temperature map 405, the predicted thermal gradient map 406, and the predicted thermal Laplacian map 501.

Refer to FIG. 5B. The operation O54 involves calculating the thermal gradient loss 504 based on the predicted thermal gradient map 406, the computed thermal gradient map 407, and the ground-truth thermal gradient map 409. Specifically, the ground-truth thermal gradient map 409 is compared with the predicted thermal gradient map 406 and the computed thermal gradient map 407, respectively, to evaluate the discrepancy between ground truths and predictions. The thermal gradient loss 504 aggregates the discrepancy between the predicted thermal gradient map 406 and the ground-truth thermal gradient map 409, as well as the discrepancy between the computed thermal gradient map 407 and the ground-truth thermal gradient map 409. This loss design guides the model toward capturing and reflecting first-order spatial relationships that adhere to the underlying physical principles.

The operation O55 involves calculating the thermal Laplacian loss 505 based on the predicted thermal Laplacian map 501, the computed thermal Laplacian map 502, and the ground-truth thermal Laplacian map 503. Specifically, the ground-truth thermal Laplacian map 503 is compared with the predicted thermal Laplacian map 501 and the computed thermal Laplacian map 502, respectively, to evaluate the discrepancy between ground truths and predictions. The thermal Laplacian loss 505 aggregates the discrepancy between the predicted thermal Laplacian map 501 and the ground-truth thermal Laplacian map 503, as well as the discrepancy between the computed thermal Laplacian map 502 and the ground-truth thermal Laplacian map 503. This loss design guides the model toward capturing and reflecting second-order spatial relationships that adhere to the underlying physical principles.

The operation O56 involves calculating the physics-aware loss 506 based on the thermal gradient loss 504 and the thermal Laplacian loss 505. In other words, the physics-aware loss 506 aggregates the thermal gradient loss 504 and the thermal Laplacian loss 505. In an embodiment, the physics-aware loss 506 is calculated as the weighted sum of the thermal gradient loss 504 and the thermal Laplacian loss 505, but the present disclosure is not limited thereto. The weights used in the weighted sum can be specified as fixed values based on practical application requirements, or they can be determined through hyperparameter tuning during the training process, but the present disclosure is not limited thereto.

In an embodiment, the image-based loss 410, the thermal gradient loss 504, and the thermal Laplacian loss 505 are calculated using mean-square error (MSE). MSE calculates the average of the squared differences between the predicted and true values. Accordingly, the image-based loss 410 can be expressed as <F3>:

$${ℒ}_{MSE} = {\sum }_{e ∈ Ω} {( {\hat{T}}_{e} - {T}_{e} )}^{2} \qquad < F 3 >$$

where [symbol] represents the image-based loss 410, Ω represents the pixel space, e represents a pixel index, \hat{T} represents the predicted temperature map 405, and T represents the ground-truth temperature map 408.

In this embodiment, the thermal gradient loss 504 is the aggregation of the MSE between the predicted thermal gradient map 406 and the ground-truth thermal gradient map 409, and the MSE between the computed thermal gradient map 407 and the ground-truth thermal gradient map 409, which can be expressed as <F4>:

$${ℒ}_{TG} = {\sum }_{e ∈ Ω} {\sum }_{n = 1}^{N} \{ {[ {( \hat{T} * {G}_{xy} )}_{e , n} - {( T * {G}_{xy} )}_{e , n} ]}^{2} + {γ}_{1} \times {[ {M}_{{TG}_{e , n}} - {( τ * {G}_{xy} )}_{e , n} ]}^{2} \} \qquad < F 4 >$$

where [symbol] represents the thermal gradient loss 504, Ω represents the pixel space, e represents a pixel index, \hat{T} represents the predicted temperature map 405, T represents the ground-truth temperature map 408, N represents the number of channels (i.e., number of directions of gradient maps), G_{xy} represents the Sobel operator, γ₁ is a hyperparameter, (\hat{T}*G_{xy}) represents the computed thermal gradient map 407, (T*G_{xy}) represents the ground-truth thermal gradient map 409, and M_{TG} represents the predicted thermal gradient map 406.

Similarly, in this embodiment, the thermal Laplacian loss 505 is the aggregation of the MSE between the predicted thermal Laplacian map 501 and the ground-truth thermal Laplacian map 503, and the MSE between the computed thermal Laplacian map 502 and the ground-truth thermal Laplacian map 503, which can be expressed as <F5>:

$${ℒ}_{TL} = {\sum }_{e ∈ Ω} \{ {[ {( \hat{T} * {L}_{xy}^{2} )}_{e} - {( T * {L}_{xy}^{2} )}_{e} ]}^{2} + {γ}_{2} \times {[ {M}_{{TL}_{e}} - {( T * {L}_{xy}^{2} )}_{e} ]}^{2} \} \qquad < F 5 >$$

where [symbol] represents the thermal Laplacian loss 505, Ω represents the pixel space, e represents a pixel index, \hat{T} represents the predicted temperature map 405, T represents the ground-truth temperature map 408,

$${L}_{xy}^{2}$$

represents the Laplacian operator, γ₂ is a hyperparameter,

$$( \hat{T} * {L}_{xy}^{2} )$$

represents the computed thermal Laplacian map 502,

$$( T * {L}_{xy}^{2} )$$

represents the ground-truth thermal Laplacian map 503, and M_{TL} represents the predicted thermal Laplacian map 501.

In combination, the final total loss can be expressed as <F6>, where α and β are hyperparameters.

$${ℒ}_{total} = {ℒ}_{MSE} + {αℒ}_{TG} + {βℒ}_{TL} \qquad < F 6 >$$

It should be appreciated that these losses can be calculated using metrics other than MSE, such as maximum temperature error (MTE) and temperature rise error (TRE), but the present disclosure is not limited thereto.

Result of an ablation experiment is presented in the <Table 1> below to demonstrate the effects of the disclosed thermal simulation method. In this ablation experiment, the same dataset was used to train three models with varying degrees of physics awareness, denoted as M1, M2, and M3, and their inference performances were compared. M1 is a purely image-based model that adopts only the image-based loss [symbol] during training. M2 is an advanced model that additionally incorporate the thermal gradient loss [symbol] along with the image-based loss [symbol] during training. M3 is a comprehensive physics-aware model that combines the image-based loss [symbol] , the thermal gradient loss [symbol] , and the thermal Laplacian loss [symbol] during training.

TABLE 1

| Error | Model Index | M1 | M2 | M3 |
|---|---|---|---|---|
| Metrics | Definition | [symbol] | [symbol] + [symbol] | [symbol] + [symbol] + [symbol] |
| MSE | (\hat{T} − T)² | 0.82 | 0.72 (−12%) | 0.58 (−29%) |
| MTE | max(\|\hat{T} − T\|) | 2.24 | 1.87 (−16%) | 1.48 (−34%) |
| MSE_{TG} | [(\hat{T} − T) * G_{xy}]² | 0.15 | 0.09 (−40%) | 0.06 (−60%) |
| MSE_{TL} | [(\hat{T} − T) * | 0.32 | 0.17 (−47%) | 0.08 (−75%) |
| | L_{xy}²]² | | | |

<Table 1> above presents the results of the ablation experiment comparing the inference performance of three models, M1, M2, and M3, trained with varying degrees of physics-aware losses. The comparison is based on error metrics, including MSE and MTE for evaluating overall inference accuracy, and MSE_{TG} and MSE_{TL} for assessing physics fidelity. The results show that as the models incorporate additional physics-aware losses (from M1 to M3), there is a consistent improvement in both accuracy and physics fidelity. M3, the comprehensive physics-aware model, demonstrates the lowest errors across all metrics, manifesting the effectiveness of integrating thermal gradient and thermal Laplacian losses during training.

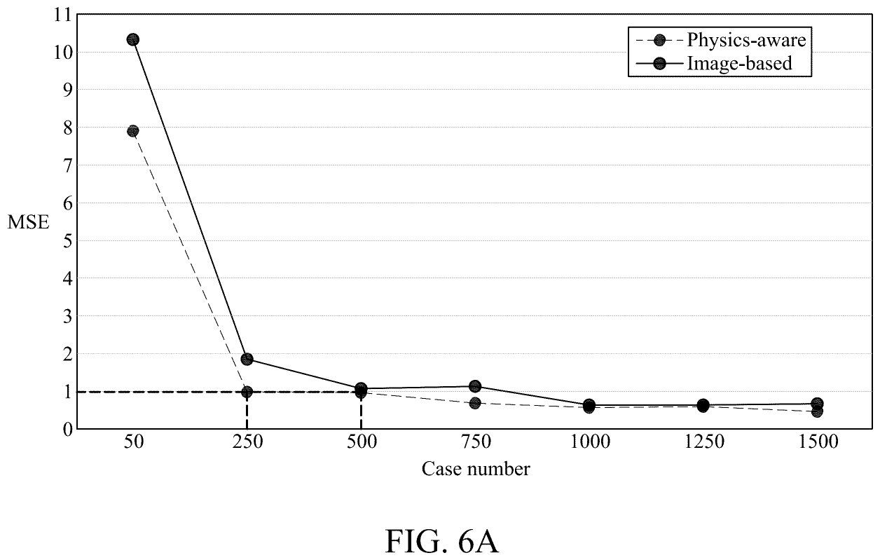

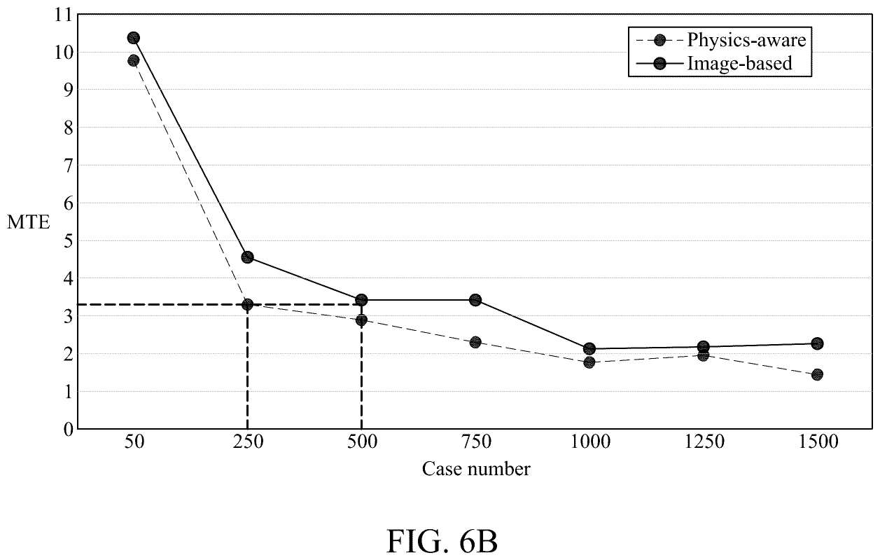

FIG. 6A and FIG. 6B illustrate the performance of the physics-aware model and the purely image-based model in terms of MSE and MTE, respectively, according to an embodiment of the present disclosure. Notably, FIG. 6A shows that the physics-aware model achieves its inflection point at 250 training samples, where further increases in training samples provides less improvements in the MSE level, whereas the purely image-based model requires 500 samples to reach a comparable level of performance. Similarly, FIG. 6B shows that the physics-aware model achieves similar error rate with half amount of the data compared to the image-based model, manifesting its high data efficiency. These results highlight that incorporating physics-aware losses not only enhances accuracy and physics fidelity but also significantly improves data efficiency, enabling the model to achieve high performance with fewer training samples.

In an embodiment, the proposed thermal simulation method, executed by the processing unit 102 of FIG. 1, may further involve identifying thermal hotspots in the temperature map generated by the temperature prediction model 120. Specifically, thermal hotspots can be identified by applying a thresholding technique, where regions in the temperature map exceeding a predefined temperature threshold are marked as hotspots. Alternatively, clustering algorithms such as k-means can be used to group adjacent high-temperature regions. Then, the method further involves adjusting the placement of components in the floorplan based on the identified thermal hotspots (for example, by interfacing the identified thermal hotspots with an electronic design automation software) to reduce thermal concentration. For example, components generating high power densities can be relocated to areas with better thermal dissipation capabilities, or heat-generating components can be spaced further apart to distribute the heat more evenly. Additionally, thermal vias or heat sinks can be strategically placed near the identified hotspots to mitigate excessive heat buildup. The SoC, after being optimized for thermal performance through the adjusted floorplan, is provided for manufacturing. This thermal optimization ensures improved operational reliability and performance, reducing the risk of thermal throttling and enhancing the overall lifespan of the manufactured device.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A thermal simulation system for a System-on-Chip (SoC), comprising:
a storage unit, configured to store a temperature prediction model;
a processing unit, configured to load the temperature prediction model from the storage unit, and use the temperature prediction model to translate a power map of a floorplan of the SoC into a temperature map;
wherein the processing unit is further configured to train the temperature prediction model by executing operations comprising:
using a power encoder and a temperature decoder to generate a predicted temperature map from a training power map;
using the power encoder and a thermal gradient decoder to generate a predicted thermal gradient map from the training power map;
applying a Sobel operator on the predicted temperature map to obtain a computed thermal gradient map;
applying the Sobel operator on a ground-truth temperature map to obtain a ground-truth thermal gradient map, wherein the ground-truth temperature map corresponds to the training power map;
calculating an image-based loss based on the predicted temperature map and the ground-truth temperature map;
calculating a physics-aware loss based on the computed thermal gradient map, the predicted thermal gradient map, and the ground-truth thermal gradient map; and
optimizing the power encoder, the temperature decoder, and the thermal gradient decoder based on the image-based loss and the physics-aware loss;
wherein the trained power encoder and temperature decoder are deployed as the temperature prediction model.

2. The thermal simulation system as claimed in claim 1, wherein the processing unit is further configured to use the power encoder and the thermal gradient decoder to generate a predicted thermal Laplacian map from the training power map;
wherein the processing unit is further configured to apply a Laplacian operator on the predicted temperature map to obtain a computed thermal Laplacian map;
wherein the processing unit is further configured to apply the Laplacian operator on the ground-truth temperature map to obtain a ground-truth thermal Laplacian map;
wherein the processing unit is further configured to calculate a thermal gradient loss based on the computed thermal gradient map, the predicted thermal gradient map, and the ground-truth thermal gradient map;
wherein the processing unit is further configured to calculate a thermal Laplacian loss based on the computed thermal Laplacian map, the predicted thermal Laplacian map, and the ground-truth thermal Laplacian map; and
wherein the processing unit is further configured to calculate the physics-aware loss based on the thermal gradient loss and the thermal Laplacian loss.

3. The thermal simulation system as claimed in claim 2, wherein the processing unit is further configured to calculate the physics-aware loss as a weighted sum of the thermal gradient loss and the thermal Laplacian loss.

4. The thermal simulation system as claimed in claim 2, wherein the image-based loss, the thermal gradient loss, and the thermal Laplacian loss are calculated using mean-square error (MSE).

5. The thermal simulation system as claimed in claim 1, wherein the processing unit is further configured to identify thermal hotspots in temperature map and adjust placement of components in the floorplan based on the identified thermal hotspots to reduce thermal concentration; and
wherein the SoC, after being optimized for thermal performance through the adjusted floorplan, is provided for manufacturing.

6. A thermal simulation method for a System-on-Chip (SoC), carried out by a computer system, the method comprising:
training a temperature prediction model; and
using the temperature prediction model to translate a power map of a floorplan of the SoC into a temperature map;
wherein the training of the temperature prediction model comprises:
using a power encoder and a temperature decoder to generate a predicted temperature map from a training power map;
using the power encoder and a thermal gradient decoder to generate a predicted thermal gradient map from the training power map;
applying a Sobel operator on the predicted temperature map to obtain a computed thermal gradient map;
applying the Sobel operator on a ground-truth temperature map to obtain a ground-truth thermal gradient map, wherein the ground-truth temperature map corresponds to the training power map;
calculating an image-based loss based on the predicted temperature map and the ground-truth temperature map;
calculating a physics-aware loss based on the computed thermal gradient map, the predicted thermal gradient map, and the ground-truth thermal gradient map;
optimizing the power encoder, the temperature decoder, and the thermal gradient decoder based on the image-based loss and the physics-aware loss;
wherein the trained power encoder and temperature decoder are deployed as the temperature prediction model.

7. The thermal simulation method as claimed in claim 6, wherein the training of the temperature prediction model further comprises:
using the power encoder and the thermal gradient decoder to generate a predicted thermal Laplacian map from the training power map;
applying a Laplacian operator on the predicted temperature map to obtain a computed thermal Laplacian map;
applying the Laplacian operator on the ground-truth temperature map to obtain a ground-truth thermal Laplacian map;
calculating a thermal gradient loss based on the computed thermal gradient map, the predicted thermal gradient map, and the ground-truth thermal gradient map;
calculating a thermal Laplacian loss based on the computed thermal Laplacian map, the predicted thermal Laplacian map, and the ground-truth thermal Laplacian map; and
calculating the physics-aware loss based on the thermal gradient loss and the thermal Laplacian loss.

8. The thermal simulation method as claimed in claim 7, the physics-aware loss is calculated as a weighted sum of the thermal gradient loss and the thermal Laplacian loss.

9. The thermal simulation method as claimed in claim 7, the image-based loss, the thermal gradient loss, and the thermal Laplacian loss are calculated using mean-square error (MSE).

10. The thermal simulation method as claimed in claim 6, further comprising:
identifying thermal hotspots in the temperature map; and
adjusting placement of components in the floorplan based on the identified thermal hotspots to reduce thermal concentration;
wherein the SoC, after being optimized for thermal performance through the adjusted floorplan, is provided for manufacturing.
